(19) United States
(12) Patent Application Publication
(10) Pub. No.: US 2020/0061862 A1
(43) Pub. Date: Feb. 27, 2020

(54) MULTI-PART LONG KNIFE

(71) Applicant: TKM GMBH, Remscheid (DE)

(72) Inventors: Thomas KLUMPEN, Mönchengladbach (DE); Volker KÖLSCH, Wermelskirchen (DE)

(21) Appl. No.: 16/463,183

(22) PCT Filed: Nov. 28, 2017
(86) PCT No.: PCT/DE2017/101028

§ 371 Date: May 22, 2019

(30) Foreign Application Priority Data
Nov. 30, 2016 (DE) 10 2016 123 079.0

(51) Int. Cl. B26D 7/26

(52) U.S. Cl. CPC B26D 7/2614; B26D 3/003

(57) ABSTRACT

A multi-part long knife (10) is provided for cutting rubberized and non-rubberized steel cord, rubber sheets with or without fiber reinforcement, industrial textiles, steel sheets and non-ferrous metals. The multi-part long knife (10) includes an elongated knife carrier (12), on which at least one elongated blade (16), having a cutting edge (18), is held. The knife carrier (12) has a clamping strip (14), which is guided in a recess (22) of the knife carrier (12) in a clamping direction (K). A receptacle (46) for the blade (16) is formed between the knife carrier (12) and the clamping strip (14), which clamping strip (14) is guided in the recess (22). A first clamping surface (50) is formed on the knife carrier (12) and a second clamping surface (52), opposite the first clamping surface (50), is formed on the clamping strip (14), between which the blade (16) can be clamped.

### CROSS REFERENCE TO RELATED APPLICATIONS

This application is a United States National Phase Application of International Application PCT/DE2017/101028 filed Nov. 28, 2017, and claims the benefit of priority under 35 U.S.C. § 119 of German Application 10 2016 123 079.0, filed Nov. 30, 2016, the entire contents of which are incorporated herein by reference.

### TECHNICAL FIELD

The invention relates to a multi-part long knife for cutting rubberized and non-rubberized steel cord, rubber sheets with or without fiber reinforcement, industrial textiles, steel sheets and non-ferrous metals having an elongated knife carrier, on which at least one elongated blade having a cutting edge is held.

### TECHNICAL BACKGROUND

Long knives are used in industrial cutting devices for the manufacture of various products. The long knives in this case have a cutting edge, which cooperates with a correspondingly formed second cutting edge which is located, for example, on a cutting table or a further long knife. The cutting devices are equipped, for example, with an upper long knife and a lower long knife, between which a cutting gap is formed. The cutting gap is closed by relative movement between the upper long knife and the lower long knife and a material arranged in the cutting gap is cut by the cutting edges.

Typical applications of such cutting devices are mainly in the field of tire manufacturing, wherein rubberized and non-rubberized steel cord and rubber sheets are cut with or without fiber reinforcement. Furthermore, industrial textiles, steel sheets, non-ferrous metals, cardboard boxes, veneers and plastic sheets are cut with generic cutting devices. Long knives in this case are usually used in lengths of less than one meter and up to six meters.

The cutting edges in this case are subject to a relatively high wear for many materials. Higher quality materials such as carbide metal can be used in order to keep this low and to achieve a longer service life of the long knife with a long-lasting sharpness of the cutting edge. Although these have advantages in terms of their service life and their temperature and corrosion resistance, they are, however, not only more difficult to machine, but also much more expensive than conventional cutting steel.

It is therefore known to use multi-part long knives, in which a knife carrier is manufactured from a cheaper material such as cutting steel and to fasten to this one or more blades made of a special material such as carbide metal. The cutting edge is then formed on the blade or blades so that a long service life and a good cutting result is achieved.

The long knives are in particular exposed to high loads in the applications mentioned, because not only the cutting, but especially the return stroke exerts high forces on the long knife due to material adhesion, so that a stable mounting of the blade on the knife carrier is required. The fastening of the blade on the knife carrier is therefore usually done by means of soldering methods for known long knives. Adhesive methods have not yet proven to be sufficiently reliable based on the loads occurring on the blade.

A connection between knife carrier and blade by means of soldering methods enables a very stable and reliable connection. However, an exchange of blades for recycling the knife carrier is not possible. Furthermore, not all materials that are advantageous for manufacturing blades can be soldered. In particular, blades made of high-grade hard metal alloys are difficult to only solder.

### SUMMARY

An object of the invention is to eliminate the disadvantages of the prior art and to provide a multi-part long knife for cutting rubberized and non-rubberized steel cord, rubber sheets with or without fiber reinforcement, industrial fabrics, steel sheets and non-ferrous metals, which is inexpensive to manufacture and allows the combination of different materials for knife carrier and blade. Furthermore, industrial textiles, cardboard boxes, veneers and plastic plates should be able to be cut with the cutting devices.

In a multi-part long knife on which at least one elongated blade having a cutting edge is held, it is provided according to the invention that the knife carrier has a clamping strip which is guided in a recess of the knife carrier in a clamping direction, wherein a receptacle for the blade is formed between the knife carrier and the clamping strip guided in the recess, wherein a first clamping surface is formed on the knife carrier and a second clamping surface opposite the first clamping surface is formed on the clamping strip, between which the blade is clamped.

The blade is held clamped between the knife carrier and the clamping strip, wherein the clamping strip is displaceable relative to the knife carrier. In this case, the blade protrudes with its cutting edge out of the receptacle and is only clamped between the clamping surfaces, without additional fastening means such as screws being required, which are guided by the blade. The blade can be removed and a new blade can be inserted by widening the receptacle between the clamping strip and the knife carrier. In this case, the first clamping surface formed on the knife carrier represents a defined contact and thus positioning for the blade. A very accurate reception of the blade without play in the knife carrier is thus possible, wherein any material pairings can be used.

The clamping direction in this case runs preferably transverse to an intended cutting direction, that is, in particular perpendicular to the cutting edge. The forces occurring during cutting and also during the return stroke of the long knife then do not act against the clamping forces between the clamping strip and knife carrier or only to a small extent. An unintentional independent release of the blade from the knife carrier is thus hardly to be feared.

In particular, the width of the receptacle can also be adapted by selecting a corresponding clamping strip, so that blades having different thicknesses can also be used. Also, the knife carrier could be combined with another clamping strip to obtain a better adaptation of the receptacle to different shaped blades.

For example, the clamping strip is formed such that, in a clamping position in which the clamping strip clamps the blade in the receptacle, it terminates flush with an outer surface of the knife carrier.

Preferably, the clamping surfaces extend parallel to a longitudinal direction and are inclined to each other. In other words, the cross-section of the receptacle widens or decreases, wherein an inward widening away from the insertion opening is preferred. In particular, the blade has a cross-section adapted to this shape. This ensures self-centering and a secure hold of the blade. Furthermore, the blade can not be inadvertently pulled out of the receptacle, for example, by adhering material, but only upon release of the clamping strip. The mutually inclined alignment of the clamping surfaces thus causes a positive connection, which prevents a withdrawal of the blade from the recess.

Alternatively, other suitable means for forming a positive connection can be present on the receptacle and/or on the blade, which make it difficult to pull the blade out of the receptacle, wherein the positive locking can be set aside when the clamping elements are released and the blade can be removed from the receptacle.

For example, the angle between the first clamping surface and the second clamping surface is between 1° and 7°, in particular between 3° and 5°, so that only a slight widening of the receptacle is required to remove the blade and high clamping forces are transferable. In addition, the preferred angle specifications compensate for the high cutting forces during cutting and back stroke at the cutting edge, whereby the service life could be significantly increased compared to known long knives.

The blade has, for example, contact surfaces for contact with the clamping surfaces, wherein the angle of the contact surfaces relative to each other corresponds to the angle of the clamping surfaces to each other or is slightly larger or smaller than this, so that a possible flat contact between the blade and clamping strip or knife carrier can be achieved. As a result, high clamping forces can be transmitted and thus a stable hold of the blade can be ensured.

A further advantage of this design of the receptacle and the blade is that a falling out of the blade from the receptacle after a pre-positioning of the clamping strip against the knife carrier or the blade is prevented. At the same time, an alignment of the blade is still possible. The blade could, for example, if the receptacle is sufficiently deep, be pushed further into the receptacle, so that initially a slight clearance is available between the blade and the receptacle, which allows a displacement of the blade. For example, the blade can also be pre-fixed by a slight clamping, so that it can not fall out of the receptacle. Subsequently, the blade is fully inserted into the receptacle, for example, until the blade rests against a bottom of the receptacle or a stop.

The clamping surfaces are preferably each inclined at an angle of 35° to 55°, in particular from 40° to 50° to the clamping direction. Since the clamping direction runs preferably perpendicular to the cutting direction, the blade is thus also arranged at an angle of about 35° to 55°, in particular from 40° to 50° to the cutting direction, so that an ideal introduction of the forces in the knife carrier occurring during cutting is possible. For example, the insertion opening of the receptacle is provided on an edge of the knife carrier, so that the inclined blade protrudes beyond the two adjacent surfaces. Cut material can thus escape into the free space below the blade and a good cutting result can thus be achieved.

The stop for the blade is preferably formed by a bottom of the receptacle. The bottom of the receptacle can be formed, at least in sections, by a stop surface of the clamping strip running essentially in the clamping direction, wherein the blade has a corresponding surface. As a result, the stop surface can receive the forces acting in the cutting direction and discharge them via the knife carrier, without the clamping strip being loaded in the opening direction. In this case, it is in particular advantageous that the blade rests against the second clamping surface, which is provided on the clamping strip, and the stop surface and is pushed by them together against the knife carrier. The blade is thus supported flat.

The bottom of the receptacle can be bounded, at least in sections, by a boundary surface of the knife carrier running essentially perpendicular to the clamping direction, wherein the blade can have a corresponding surface. When the blade is clamped, this is then pushed by the inclined orientation of the clamping surfaces in the direction of the bottom until the blade is located completely in the receptacle and rests against the bottom of the receptacle. As far as possible, there should still be a slight gap to the boundary surface in order to avoid excessive tension in the blade.

At least one guide for the clamping strip can be provided on the knife carrier, and the clamping strip has at least one projection projecting into the guide. As a result, the clamping strip is aligned in the desired position on the knife carrier and can be displaced into the clamping direction. For example, the guide and the projection can extend over the entire width of the long knife. However, it is also possible that they extend only over partial regions of the knife carrier and the clamping strip, so that the clamping strip is fixed on the knife carrier in the longitudinal direction of the clamping strip.

Preferably, the stop surface in this case is formed on the projection. Sufficient material for the stop surface is available through the projection, which is accordingly able to receive higher forces.

In a preferred embodiment, the clamping strip is held on the knife carrier via a plurality of clamping elements arranged side by side in the longitudinal direction, wherein the clamping elements are guided in particular by the projection. A homogeneous clamping force can thus be generated in the longitudinal direction.

Preferably, the clamping elements are formed as screws which are rotatably held in the knife carrier or in the clamping strip and engage in a thread provided on the clamping strip or the knife carrier, so that a continuous clamping of the clamping strip against the knife carrier or the blade is possible. For example, the screws are arranged in the region of the guide and the projection and extend through the projection. The screws thus do not come into contact with the blade.

The screws in this case are preferably arranged in the sheet running direction at a front side of the long knife. The region below the blade, in which the cut material is pressed, can thus remain free.

Preferably, the screw head is arranged countersunk on the knife carrier or on the clamping strip, so that no components protrude beyond the surfaces of the knife carrier or the clamping strip except the blade.

Further features, details and advantages of the invention will become apparent from the wording of the claims and from the following description of embodiments with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a long knife according to the invention;

FIG. 2 is a plan view of the long knife of FIG. 1;

FIG. 3 is a sectional view of the long knife of FIG. 1;

FIG. 4 is a sectional view of the long knife of FIG. 1 in the region of the blade;

FIG. 5 is a sectional view of the long knife of FIG. 1 in the region of the clamping strip and the blade;

FIG. 6 is a sectional view of the knife carrier of the long knife of FIG. 1;

FIG. 7 is a sectional view of the clamping strip of the long knife of FIG. 1; and

FIG. 8 is a sectional view of the blade of the long knife of FIG. 1.

### DESCRIPTION OF PREFERRED EMBODIMENTS

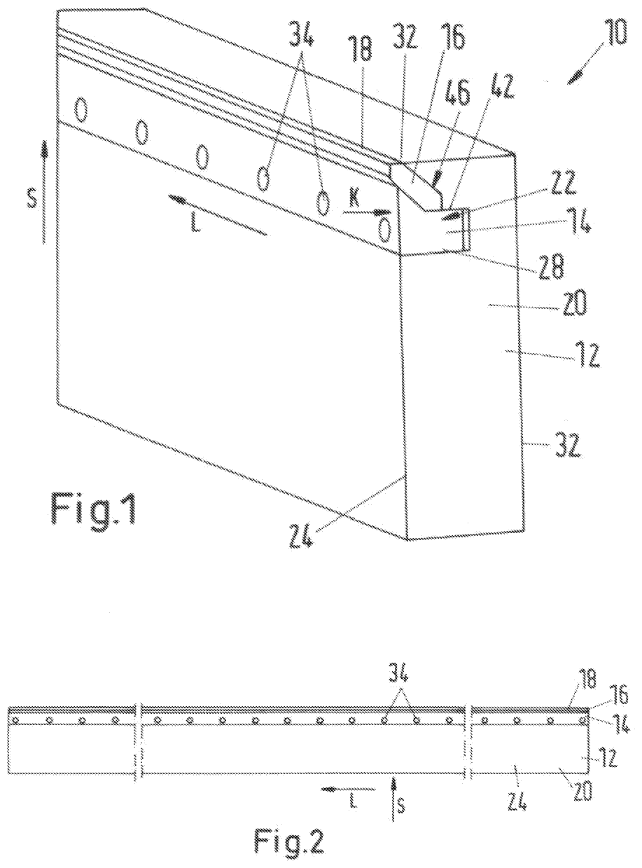

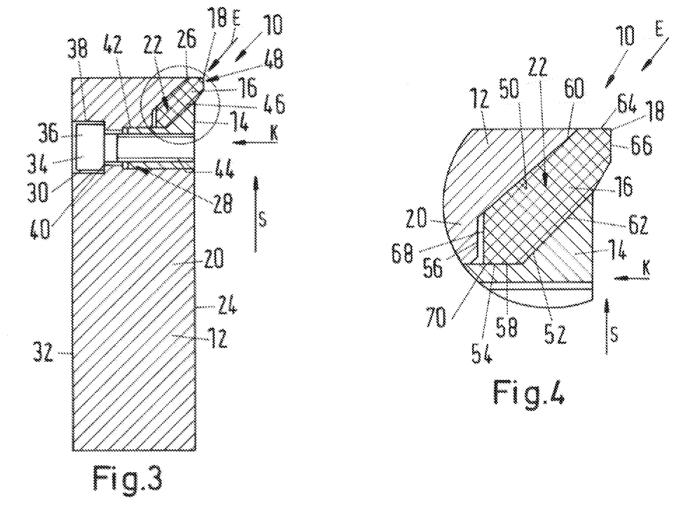

Referring to the drawings, FIGS. 1 to 3 show a concrete embodiment of a long knife 10 according to the invention for cutting rubberized and non-rubberized steel cord, rubber sheets with or without fiber reinforcement, industrial textiles, steel sheets and non-ferrous metals for a cutting device, not shown. The long knife 10 has a knife carrier 12, a clamping strip 14 and a blade 16 having a cutting edge 18. The long knife 10 is inserted into a cutting device such that the cutting edge 18 moves relative to a second, corresponding cutting edge in a cutting direction S and a material located in the cutting gap between the cutting edges can be cut.

The knife carrier 12 has a substantially cuboid base body 20 which extends in a longitudinal direction L (see also FIG. 6). Means for mounting the long knife 10 are provided in a cutting device on the base body 20, not shown here. A recess 22 is formed on the base body 20, which recess extends in a longitudinal direction L running perpendicular to the cutting direction S over the entire base body 20.

The recess 22 extends from a surface 24 of the base body 20 running in the cutting direction S into the base body, wherein the recess 22 is directed away from a front edge 26 in the cutting direction S. The recess 22 has a guide 28 in the form of a groove having a rectangular cross-section extending transverse to the cutting direction in the base body 20 and in the longitudinal direction L over the entire length of the base body. The guide 28 opens into a plurality of holes 30 extending through the base body 20. From the surface 32 opposite the surface 24, a plurality of clamping elements 34 formed as screws having an external thread extend through the holes 30 and the guide 28 in the recess 22. The screw heads 36 are countersunk in recesses 38 provided on the surface 32 of the base body 20 so that they do not protrude beyond the surface 32. The screw heads 36 in each case lie at the bottom 40 of the recesses 38.

The clamping strip 14 (see also FIG. 7) extends in the longitudinal direction L over the entire length of the knife carrier 12 and has a projection 42 which protrudes into the guide 28 in a clamping direction running transversely to the longitudinal direction L and transversely to the cutting direction S, so that the clamping strip 14 is displaceably mounted on the knife carrier 12 in the clamping direction K. A plurality of holes 44 corresponding to the holes 30 and the clamping elements 34 are provided in the clamping strip 14, which plurality has internal threads corresponding to the threads of the clamping elements 34. The clamping elements 34 extend into the holes 44 and into the internal threads. The clamping strip 14 can be displaced parallel to the clamping direction against the knife carrier 12 by turning the clamping elements 34.

A receptacle 46 for the blade 16 is formed between the clamping strip 14 and the knife carrier 12, which receptacle extends from an insertion opening 48 at the edge 26 obliquely between knife carrier 12 and clamping strip 14. The width of the receptacle 46 is reduced by moving the clamping strip 14 in the clamping direction K, so that the blade 16 is clamped in the receptacle 46 between the clamping strip 14 and the knife carrier 12.

The receptacle 46 is closed by a first clamping surface 50 provided on the knife carrier 12 and a second clamping surface 52 and a bottom 54 provided on the clamping strip 14. The bottom 54 is bounded by a boundary surface 56 provided on the knife carrier 12 and running perpendicular to the clamping direction K, and formed by a stop surface 58 provided on the clamping strip 14 and running in the clamping direction K.

The first and the second clamping surface 50, 52 run at an angle between 40° and 50° to the cutting direction S, wherein the clamping surfaces 50, 52 enclose an angle between 3° and 5°, so that the receptacle 46 widens away from the insertion opening 48 in the direction of the bottom 54.

The blade 16 has surfaces 60, 62 corresponding to the clamping surfaces 50, 52 which are also inclined towards each other and enclose an angle of approximately 3° to 5°. In particular, the angle enclosed by the surfaces 60, 62 corresponds to the angle between the clamping surfaces 50, 52 or is slightly greater or smaller than this.

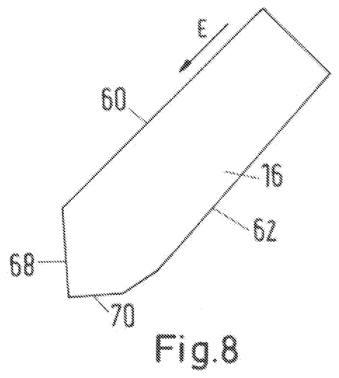

A cutting edge 18 is provided at a rear end of the blade 16 in the insertion direction E, which cutting edge is formed by two partial surfaces 64, 66 at an angle to each other, wherein a first partial surface 64 runs in the cutting direction S. The second partial surface 66 runs substantially perpendicular to the first partial surface 64 or to the cutting direction S. Two substantially mutually perpendicular surfaces 68, 70 are provided at the opposite front end, which surfaces are aligned adjacent to the boundary surface 56 or to the stop surface 58. The transition between the surface 70 associated with the stop surface 58 and the second surface 68 is rounded (see in particular FIGS. 4, 5 and 8).

For mounting the blade 16, the clamping strip 14 is displaced such that the receptacle 46 is sufficiently wide to receive the blade 16. Subsequently, the blade 16 is inserted in the insertion direction E into the receptacle 46 until the second surface 62 rests against the second clamping surface 52 and the second surface 70 against the stop surface 58. After the insertion of the blade 16, the clamping strip 14 is moved by rotating the clamping elements 34 in the clamping direction K against the knife carrier 12 until the first surface 60 rests against the first clamping surface 52. By further rotation of the clamping elements 34, the clamping strip 14 is pre-tensioned against the knife carrier 12 and the blade 16 is clamped in the receptacle 46 between the clamping strip 14 and the knife carrier 12.

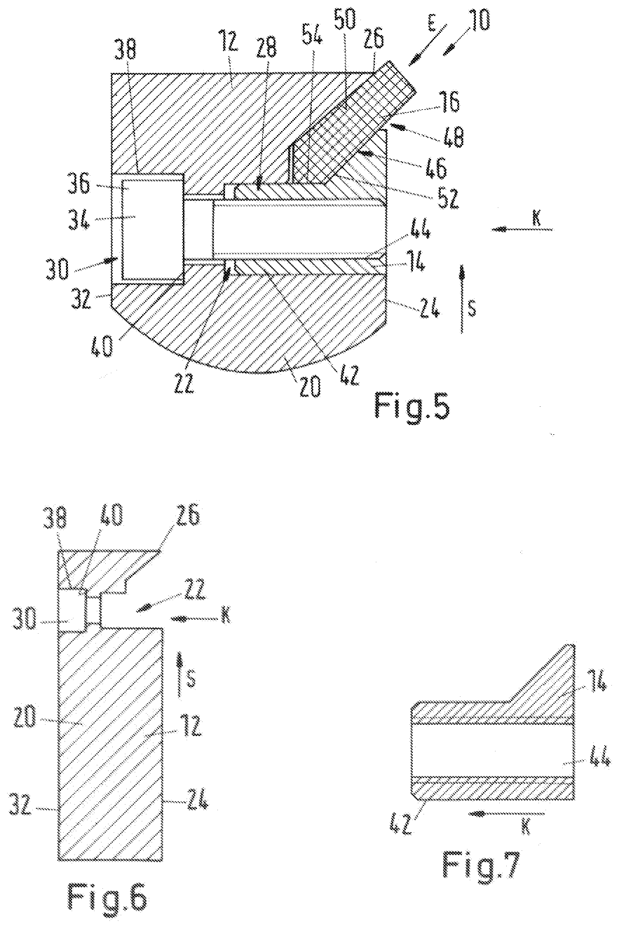

As can be seen in particular in FIGS. 4 and 5, the blade 16 is clamped between the clamping surfaces 50, 52 and the stop surface 58 without play, wherein the blade 16 in the clamping position shown is spaced from the boundary surface 56.

The blade 16 in this case is clamped such that the cutting edge 18 protrudes beyond the adjacent surface 24, so that there is space for the cut material below the blade 16 or the cutting edge 18. FIG. 5 shows a state in which an upper edge of the blade 16 projects beyond an upper side of the knife carrier. However, this projection is abraded after insertion of the blade 16, so that a flat surface is obtained, over which the material to be cut can be moved smoothly.

In particular, the clamping elements 34 are countersunk in such a way that even with usage-related wear on the surfaces 24, 32, they do not project beyond the surfaces 24, 32. Also, the receptacle 28 and thus the position of the blade 16 are independent of a usage-related wear on the surfaces.

The invention is not limited to one of the above-described embodiments, but can be modified in many ways. Thus, for example, the knife carrier can not only have a receptacle for a blade, but also a plurality of receptacles with accordingly many clamping strips. Preference is given to an embodiment having two receptacles for two blades, which are arranged under each other or diagonally opposite each other. When a blade is worn, the other blade can then be used by first turning the long knife, before a completely new knife or at least an exchange of the blades is required.

All features and advantages arising from the claims, the description and the drawing, including design details, spatial arrangements and method steps can be essential to the invention both in itself and in various combinations.

While specific embodiments of the invention have been shown and described in detail to illustrate the application of the principles of the invention, it will be understood that the invention may be embodied otherwise without departing from such principles.

1. A multi-part long knife for cutting rubberized and non-rubberized steel cord, rubber sheets with or without fiber reinforcement, industrial textiles, steel sheets and non-ferrous metals, the knife comprising:
at least one elongate blade with a cutting edge;
an elongate knife carrier on which the at least one elongate blade with the cutting edge is held, wherein the knife carrier comprises a clamping strip which is guided in a recess of the knife carrier in a clamping direction, wherein a receptacle for the blade is formed between the knife carrier and the clamping strip guided in the recess, wherein a first clamping surface is formed on the knife carrier and a second clamping surface opposite the first clamping surface is formed on the clamping strip, between which the blade can be clamped.

2. The long knife according to claim 1, wherein the clamping surfaces extend parallel to a longitudinal direction and are inclined to each other.

3. The long knife according to claim 2, wherein an angle between the first clamping surface and the second clamping surface is between 1° and 7°.

4. The long knife according to claim 1, wherein the blade comprises contact surfaces for contact with the clamping surfaces, wherein the angle of the contact surfaces relative to each other corresponds to the angle of the clamping surfaces to each other or is smaller or larger than this.

5. The long knife according to claim 1, wherein the clamping surfaces are each inclined at an angle of 35° to 55°, to the clamping direction.

6. The long knife according to claim 1, wherein a bottom of the receptacle is formed at least in sections by a stop surface of the clamping strip running substantially in a clamping direction, wherein the blade has a corresponding surface.

7. The long knife according to claim 6, wherein the bottom of the receptacle is bounded at least in sections by a boundary surface running substantially perpendicular to the clamping direction, which boundary surface is formed on the knife carrier.

8. The long knife according to claim 1, wherein at least one guide for the clamping strip is provided on the knife carrier and the clamping strip comprises at least one projection projecting into the guide.

9. The long knife according to claim 8, wherein:
a bottom of the receptacle is formed at least in sections by a stop surface of the clamping strip running substantially in a clamping direction, wherein the blade has a corresponding surface; and
the stop surface is formed on the projection.

10. The long knife according to claim 1, further comprising a plurality of clamping elements, wherein the clamping strip is held on the knife carrier via the plurality of clamping elements arranged next to each other in the longitudinal direction, wherein the clamping elements are guided by the projection.

11. The long knife according to claim 10, wherein the clamping elements are formed as screws which are rotatably held in the knife carrier or in the clamping strip and engage in a thread provided on the clamping strip or on the knife carrier.

12. The long knife according to claim 1, wherein an angle between the first clamping surface and the second clamping surface is between 1° and 7°
